(19) United States
(12) Patent Application Publication
(10) Pub. No.: US 2008/0156251 A1
(43) Pub. Date: Jul. 3, 2008

(54) Boater safety flag

(76) Inventor: George Rinaldi, St. Clair Shores, MI (US)

Correspondence Address: GEORGE RINALDI, 22461 LAVON, ST. CLAIR SHORES, MI, 48081, US

(21) Appl. No.: 11/998,375

(22) Filed: Nov. 29, 2007

Related U.S. Application Data
(60) Provisional application No. 60/877,580, filed on Dec. 29, 2006.

(51) Int. Cl. G09F 17/00

(52) U.S. Cl. 116/173

(57) ABSTRACT

The part I am presenting to you is a round plastic tube with a slit down the side. At the top of the tube there are other cuts at right angles which are there for the lock. At the top of the tube is a cap with a hole in it. The flag wire is made of stainless steel and is installed through an opening at the top and is fed through the tube until it reaches the bottom.

At the top of the wire, the flag is installed with reflective material that is orange in color and is waterproof. A lock measuring a ½″ will be welded to the bottom of the wire and a cork will be placed over the lock. There are two straps which are blind riveted to the tube.

Buckles on the straps will secure the device through the arm hole on the safety vest. The flag at the top of the wire when fully extended will measure 21¼″ above the top cap. There will be no rust or corrosion on any part of the device. If this device is worn by people in the water because of a boating accident they will have a better chance of being seen more quickly by air, land or sea.

The petitioner whose signature appears on the declaration attached respectfully requests that letter patent be granted to such petitioner for the new and original design set forth in the following specification. The filing fee of $515.00, sheets of declaration, utility design patent application and a letter of claim and a return postcard is attached.

The undersigned has invented a new, original boating flag that will be above the head of the person who wears it.

The specification to the accompanying drawing is a part which is described as follows:

### CROSS REFERENCE TO RELATED APPLICATIONS

YES

### STATEMENT REGARDING FEDERALLY SPONSORED RESEARCH

NONE

### DRAWING FIGURES

FIG. 1 is a front elevation view of my Boating Flag.

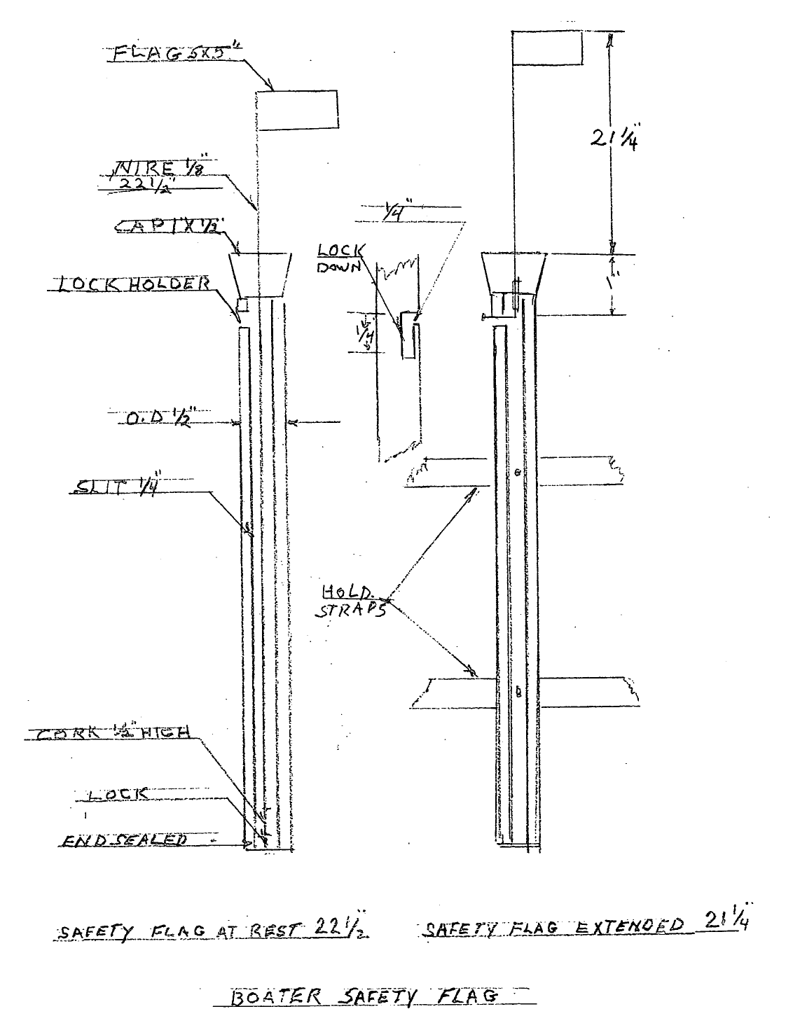

Patent application of George Rinaldi for the Boater Safety Flag.

This personal device used by boaters or others when they find themselves in the water and damage has been done. The device should be put on when boating. The flag will be above the water.

1. The closure of claim is said to be a tube with a wire in it that goes up or down and a flag glued to the top of the wire. There is a locking devise that will hold the flag in the upright position. At the bottom there is a cap with holes 1/16″ centers, the cap will be glued to the plastic. On the top of the tube is another cap 1″×½″ with a hole drilled into it ¼″.

2. The closure of claim is that the tube is made of plastic ½″ O.D. It will be slit down the 180 degree center ⅛″ wide. There will be two more cuts 90 degrees from the slit and ½″ from the top and 3/16″ wide. The second cut will be ¼″ down, 3/16″ wide. These cuts are for the locking devise.

3. The closure of claim is the wire that goes into the tube will be 22½″ long and will be pushed down the tube through the top cap, the cork will be installed on the wire on the bottom

4. The closure of claim. At the end of the locking wire will have a finger knob welded to the locking devises. The locking wire will be ¾″ long. The flag will be reflective material attached to the top of the 22½″ wire when it is fully deployed it will be 21¼″

5. The closure of claim. The completed tube will have two holding straps. These holding straps will be connected to the tube by blind revets. The strap will be at 5″ from the top and another one 10″ from the top. A sliding buckle will be on each strap. It is fastened to the safety jacket through the arm opening.

6. The closure of claim is built with a plastic tube ½″ in diameter and with a plastic tube ½″ in diameter and with a slit measured 180 degrees. The wire will be 21¼″ from the top. It will be above the person wearing it by about 9 inches.
